(19) United States
(12) Patent Application Publication
(10) Pub. No.: US 2002/0173860 A1
(43) Pub. Date: Nov. 21, 2002

(54) Integrated control system

(76) Inventors: Charles W. Bruce, Rogers, AR (US); Richard T. Calvin JR., Rogers, AR (US)

Correspondence Address: DOWELL & DOWELL, P.C., Ralph A. Dowell, Suite 309, 1215 Jefferson Davis Highway, Arlington, VA, 22202, US

(21) Appl. No.: 09/855,035

(22) Filed: May 15, 2001

(51) Int. Cl. G05B 11/01

(52) U.S. Cl. 700/17

(57) ABSTRACT

An integrated control system for controlling and monitoring at least one machine is provided. The integrated control system includes a means for programming instructions for generation of control signals for the controlled machine. The control system of the present invention includes a real-time operating system, a virtual integration of a PLC, an MC and an MMI into one seamless multi-tasking application. The PLC and MC are embedded in the software architecture of the integrated control system and operable by a single processor, and these components have access to the same memory means via a bus.

### FIELD OF THE INVENTION

The present invention related to control systems and more particularly to virtual integrated control systems.

### BACKGROUND OF THE INVENTION

Traditionally control systems have been operated by three separate computer systems, each with it's own proprietary operating system. The three components are a programmable logic controller (PLC), a motion controller (MC) and a man-machine interface (MMI). The PLC effects discrete on/off control functions, the MC serves instructions to servo motors, while the MMI allows an operator to interact with the machine under control, either directly or through the PLC and MC via a display screen and a keyboard.

Several problems arise through the implementation of the traditional approach, since proprietary operating systems, software, hardware and programming languages may not be interoperable. Therefore, this may force an end user to purchase all components from one manufacturer to ensure hardware and software compatibility, or else, extensive programming and additional patches are required to interface or integrate the different computer systems. The resultant volume of additional programming code leads to substantial costs, limits on speed and efficiency of the underlying manufacturing application, and limits the compatibility with other computer systems. Other disadvantages of this approach are substantially higher hardware and software costs, complexity of system design and build.

However, there has been a migration of proprietary PLC, MC and MMI based systems to open architecture PC-based systems. The main advantages of PC-based control systems are, open-architecture/networking, substantially lower hardware costs, increased flexibility and access to third part software.

Accordingly, it is an object of the present invention to mitigate at least one of the above-mentioned drawbacks.

### SUMMARY OF THE INVENTION

In one of its aspects, the present invention provides an integrated control system for controlling and monitoring at least one machine. The integrated control system includes a means for programming instructions for generation of control signals for the controlled machine.

The control system of the present invention includes a real-time operating system, a virtual integration of the three box control system, that is, the PLC, MC and MMI into one seamless multi-tasking applications. The PLC and MC are embedded in the software architecture of the integrated control system and operable by a single processor, and these components have access to the same memory means via a bus. The microprocessor executes input and output scans to read the data from input modules and transmit output status data to output modules, where the input/output modules are associated with the machine. Also, the system includes a memory means for storing the machine control instruction and data acquired from input/output modules of the machine under control.

The processor also executes a program scan in which the instructions are presented to the machine. The instructions are programmed into the control system via an interface which includes a display means and an input means. The memory means is linked into a plurality of portions, for storing the programs, data, and operating tasks data, such that data is stored in FIFO registers and is shifted serially into registers or cache of registers during a cycle or program scan.

### DESCRIPTION OF THE DRAWINGS

These and other features of the preferred embodiments of the invention will become more apparent in the following detailed description in which reference is made to the appended drawings wherein:

FIG. 1 shows a prior art control system including three separate main components, a PLC, an MC and a MMI;

FIG. 2 shows an integrated control system having one software-based application on a computer, in a preferred embodiment;

FIG. 3 shows a main display on the MMI for administering the integrated control system:

FIG. 4 shows a configuration and diagnostics screen on the MS;

FIG. 5 shows a ladder diagram programming screen for the integrated control system;

FIG. 6 shows a drive configuration screen for displaying and editing the motion profile of the machine;

FIG. 7 shows a SERCOS diagnostics screen including positioning information and velocity of axes;

FIG. 8 shows a list of digital inputs that may be monitored, including an option to view digital outputs of an input/output module;

FIG. 9 shows an oscilloscope screen on the MMI for tracking user-defined inputs and outputs from probes within the system; and

FIG. 10 shows an overview report screen having the machine operational information.

### DESCRIPTION OF THE PREFERRED EMBODIMENTS

At present personal computer-based automation system, designated by numeral 10 as shown in FIG. 1 of the prior art, are currently used in the form of a PLC 14 and a motion controller 16 combined with a PC 12 with a coprocessor card for PLC/MC tasks. Typically, the PC 12 is not entrusted directly with control tasks. Instead, auxiliary processor on the PLC 14 and MC 16 executes these control tasks. This structure is disadvantageous for the reasons expressed above.

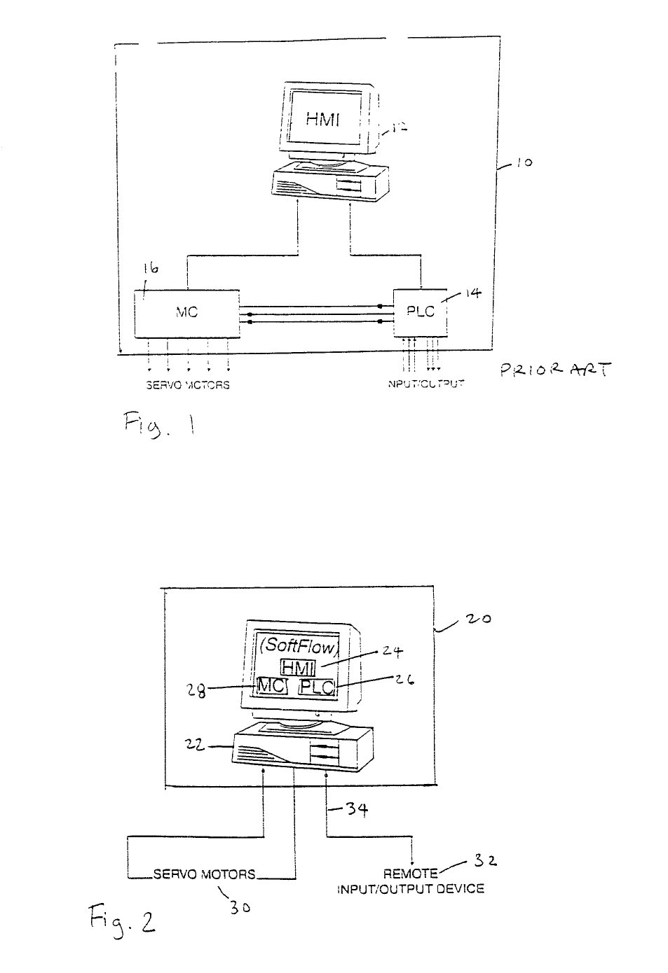

In a preferred embodiment the discrete PLC, MMI and MC components are integrated into one seamless multitasking application on a PC, as shown in FIG. 2 and designated generally by the numeral 20. Therefore, the integrated control system 20 includes a PC 22 which provides an MMI 24 for interaction with the system 20, a PLC 26, a MC 28, including one processor responsible for all automation tasks in a single-processor mode of operation. Therefore, contrary to the traditional approaches, with the integrated control system a separate processor system including memory and operating system is substituted by real time-compatible deterministic processing of functions for the PLC and MC with to the PC processor and in its memory. Thus the PC 22 includes PLC and an MC functions integrated in the architecture and executable by the PC itself without requiring a separate PLC or MC.

Looking at FIG. 2, the PC 22 includes a processor means, an open field bus system 34 for I/O links, an operating system for the user interface (MMI) 36 and proprietary system software 38. The proprietary language is based on the IEC 1131-3 international standard for programmable controller programmable languages. As such, it specifies the syntax, semantics and display for the following suite of PLC programming language, such as a ladder diagram (LD). The PC 22 maybe an computer with an operating system such as Windows 2000 or Unix, with a input device such as a keyboard, touch-screen, pen-based input device or microphone coupled to a voice-recognition engine, an output display monitor and storage means such as storage devices.

In the preferred embodiment, the system 20 provides almost unrestricted memory space for programs and data, and since the functionalities of the PLC 26 and MC 28 are fully integrated in the operating system, the PC 22 resources, such as memory, are accessed with methods of the operating system for substantially high system reliability.

Typically, a PLC 26 includes a plurality of input and output modules 32 communicatively coupled to the processor module, which repeatedly executes instructions of a stored control program. The input and output modules 32 interface with sensing and actuating devices on machinery operated by the PLC 26. The processor module preferably includes executes a user defined control program that examines the status of selected sensing devices and controls actuating devices on the machinery to execute the complex ladder logic instructions.

The control program instruction set includes instructions which define an operation that is performed by a routine written in ladder logic instructions. The instructions specify an operation code, a first file containing data to be processed by the instruction, and a storage location for results produced by execution of the instruction. If required by the function to be performed, the instructions also specified a second file containing control data for the function. The first and second files are stored in one section of memory. A second memory section contains an instruction routine having a plurality of ladder logic instructions which typically are executed by said ladder logic processor in response to execution of the instruction. During the execution of the instruction routine; the ladder logic processor obtains the required data from the first file. At the completion of the routine, the results of the processing are stored at the location specified in the instruction.

In the preferred embodiment, the PLC 26 is capable of executing a number of instructions. The ladder logic routines for the instructions are stored in a common library file in the second memory section. A directory is provided which lists a unique operation code for each instruction for each operation code, a starting address of the instruction routine in the second memory section. The directory facilitates access to the appropriate routine in order to perform the operation called for by the instruction. In accordance with the invention, an integrated control system 20 comprises one or more controllers each equipped to perform a control function and to gather data, ordinarily from sensors, relevant to the control function. “Relevant” data includes, at a minimum, any information upon which control decisions are made or states shifted, but can also include information obtained from sensors not directly connected to the controller but which is nonetheless meaningful to supervisory personnel.

As mentioned above, the PC 22 executes program instructions to operate the machine, the processor means is typically a central processing unit (CPU) and the memory means comprises one or more computer storage devices. Ordinarily, the storage device is composed of a combination of volatile RAM for temporary storage and processing, and non-volatile, programmable read-only memory (PROM) that contains permanent aspects of the controller's operating instructions; however, computer storage can, if desired, include mass-storage facilities such as a hard disk or CD-ROM.

The processor and the computer storage devices communicate with each other over a primary bus. The system further includes a series of input/output modules shown representatively at that sense the condition of, and send control signals to, the controlled machine over a communication link. This communication link facilitates the bi-directional exchange of signals between each I/O module and an associated device, for example a sensor or an actuator. I/O modules 32, as well as machine interfaces reside on or define a secondary I/O bus, in effect, the primary bus and the secondary bus form a single logical bus.

The memory means contains a series of functional blocks or modules that implement the functions performed by control system 20 through operation of CPU. For example, a control block may contain instructions for operating I/O modules 32. These instructions are read in rapid sequence and interpreted to examine the condition of selected sensing devices associated with the controlled equipment, and, based thereon, to cause the controller to send appropriate operative control signals to the equipment.

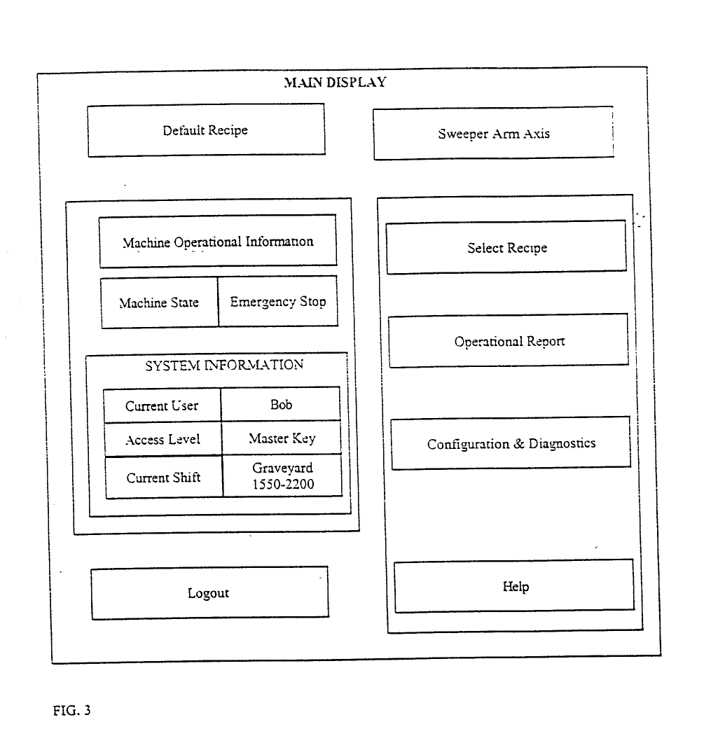

In order to describe the integrated control system 20 in more detail, the specifics of the single software application that is fully integrated in the operating system of the PC 22 will be outlined with particular reference to FIGS. 3, 4, 5, 6,7, 8,9, 10 and 11.

### Main Display

Looking at FIG. 3, which shows the main display of the MMI 24, the following options are available; the system information which includes the system information, the machine operational information, configuration and diagnosis, operational report and program selection. The system information includes a login prompt for users. All authorized users are assigned certain access rights to the operation of the system, for example a foreman may have complete rights, which may be level 4, while a junior machinist may have a level 1 access, which allows minimal access to the system. For security and accounting purposes the current user, access level and time information is displayed and stored in memory.

In a preferred embodiment the current state of the machine is displayed, including the machine speed, in a case of a packaging machine, the number of packages per minute and the package count is also displayed.

### Configuration

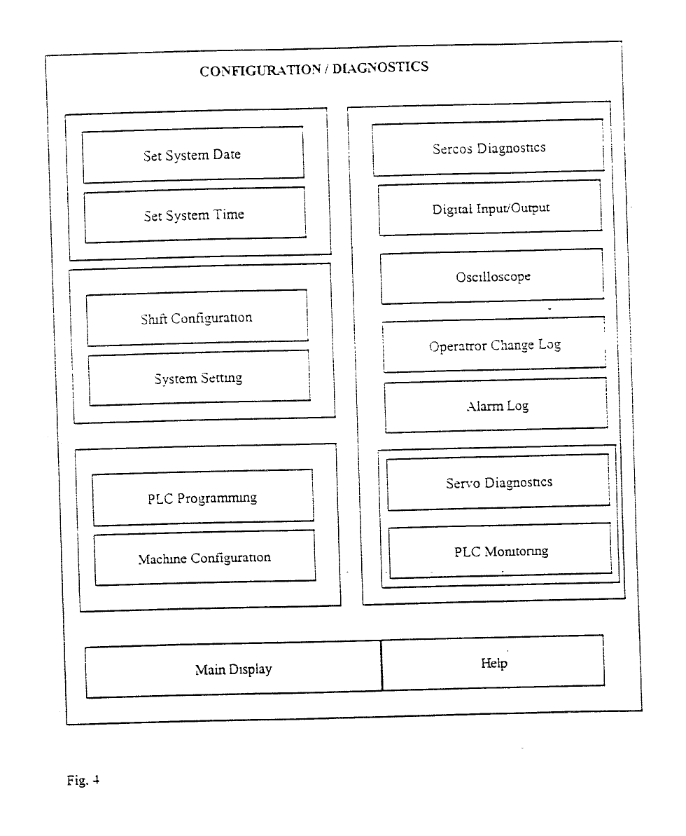

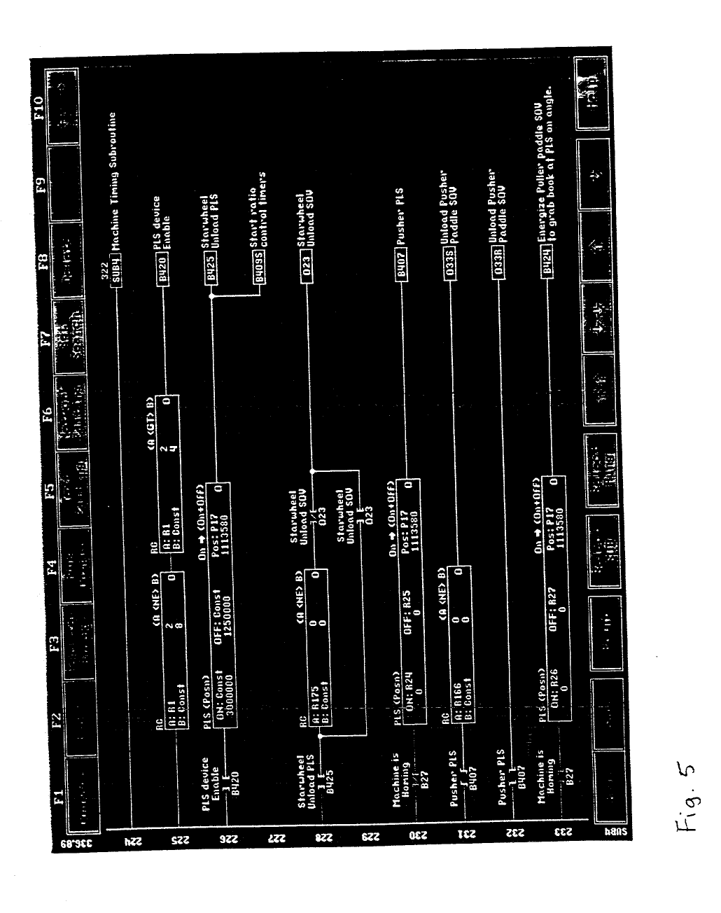

Now turning to FIG. 4, the control system may be programmed via this interface by selecting the ‘Diagnostics Option' from screen display of FIG. 3. As mentioned above, the programming of the system is available via the configuration and diagnostics option, In this configuration screen, the system settings such as date and time can be set, including shift configuration and system security. System security is preferably performed by an administrator, who sets up usernames and passwords, including the assigning of access level to the users.

### PLC Programming

PLC programming is performed via the MMI, where the programming employs a C.A.S.E. tool approach, as shown in FIG. 5. This approach substantially reduces source code customization and configuration. The instructions are written in a high level language, such as C, to permit manipulation of input/output data, data transfer and other complex tasks. A PLC program includes objects such as functions, function blocks, and programs, data types, resources, and libraries. In the preferred embodiment, the PLC operates according to rung ladder diagrams that substantially emulate the older relay logic previously used to control machines.

The ladder diagram is a graphics oriented programming language which approaches the structure of an electric circuit and is suitable for constructing logical switches, on the other hand one can also create networks. The control system includes a software module to convert such ladder diagrams into code understandable by the PLC. Therefore, all the terms like switch relay, bell, etc are converted into symbols. Each device is given an address and the schematic diagram is converted into a logical sequence of events. The rung ladder diagrams include contacts, blocks such as counter and timer, read and write register blocks, rung output.

Therefore the ladder diagram generally consists of a series of networks and is useful for controlling the call of other programs. A network is limited on the left and right sides by a left and right vertical current line and in the middle is a circuit diagram made up of contacts, coils, and connecting lines. Each network consists on the left side of a series of contacts which pass on from left to right the condition “ON” or “OFF” which correspond to the Boolean values TRUE and FALSE. To each contact belongs a Boolean variable. If this variable is TRUE, then the condition is passed from left to right along the connecting line. Otherwise the right connection receives the value OFF.

Each network in a ladder diagram consists on the left side of a network of contacts which from left to right show the condition “On” or “Off”. These conditions correspond to the Boolean values TRUE and FALSE, A Boolean variable is assigned to each contact and if this variable is TRUE, then the condition is passed on by the connecting line from left to right, otherwise the right connection receives the value “Out”. Contacts can be connected in parallel, in which case one of the parallel branches must transmit the value “On” so that the parallel branch transmits the value “On”; alternatively the contacts may be connected in series. This therefore corresponds to an electric parallel or series circuit. A contact can also be negated, recognizable by the slash in the contact symbol: |/|, in which case the value of the line is transmitted if the variable is FALSE.

Also, function blocks and programs may be entered in a ladder diagram network they must have an input and an output with Boolean values and can be used, at the same places as contacts, that is on the left side of the ladder diagram network. Also available is the option to edit the text and the network including the option to Search for specific registers or contacts.

### Drive Configuration

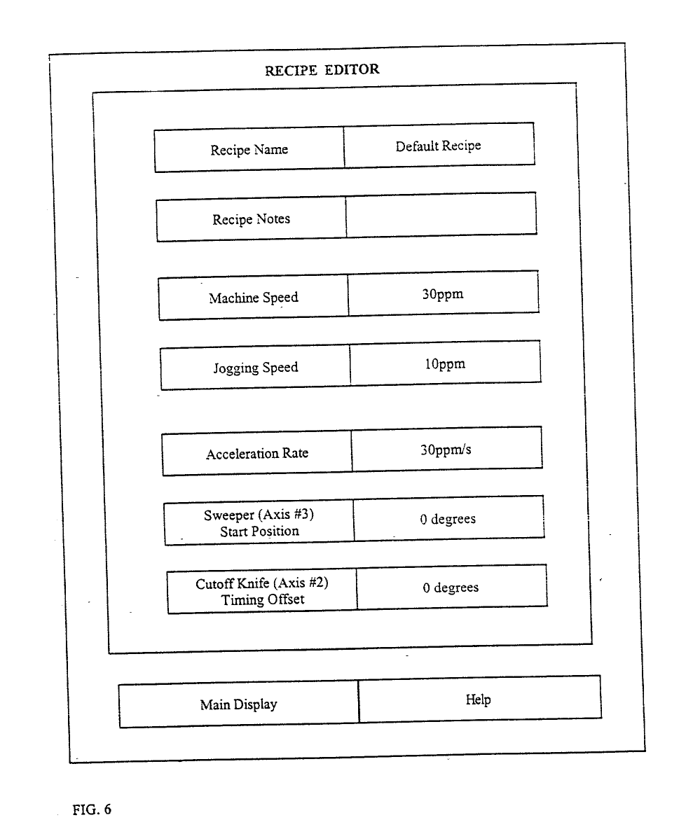

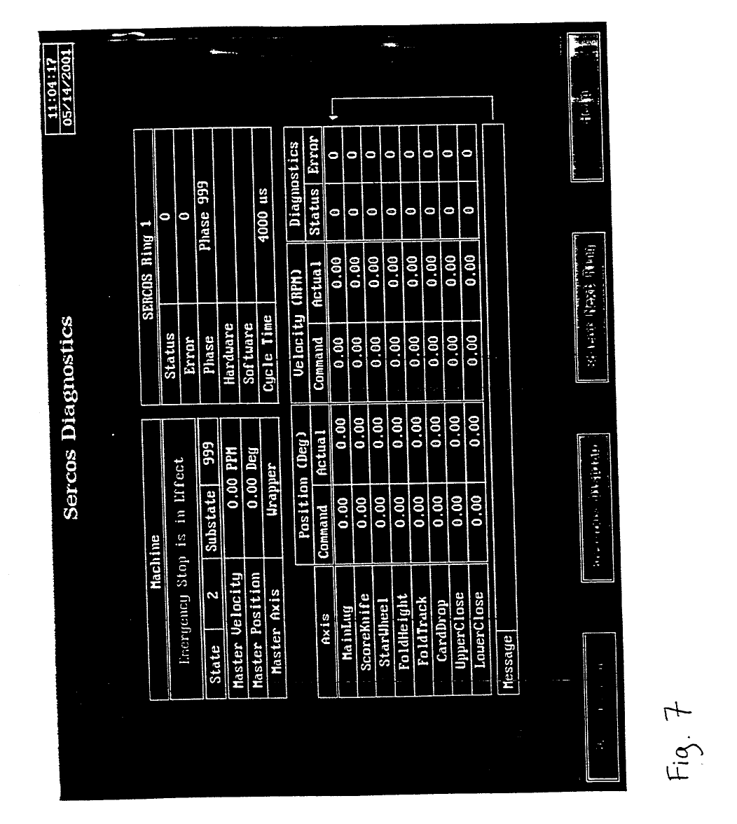

The drive configuration includes the machine configuration, as shown in FIG. 6. This includes the machine name, axis information and the number of input/output racks, including the number of probes used. The motion of the machines can be edited too.

### PLC Monitoring

Any runs or subroutine can be selected and displayed for monitoring purposes.

### Drive Diagnostics

Drive Diagnostics includes current axis, master axis, drive mode and drive state.

### Sercos Diagnostics

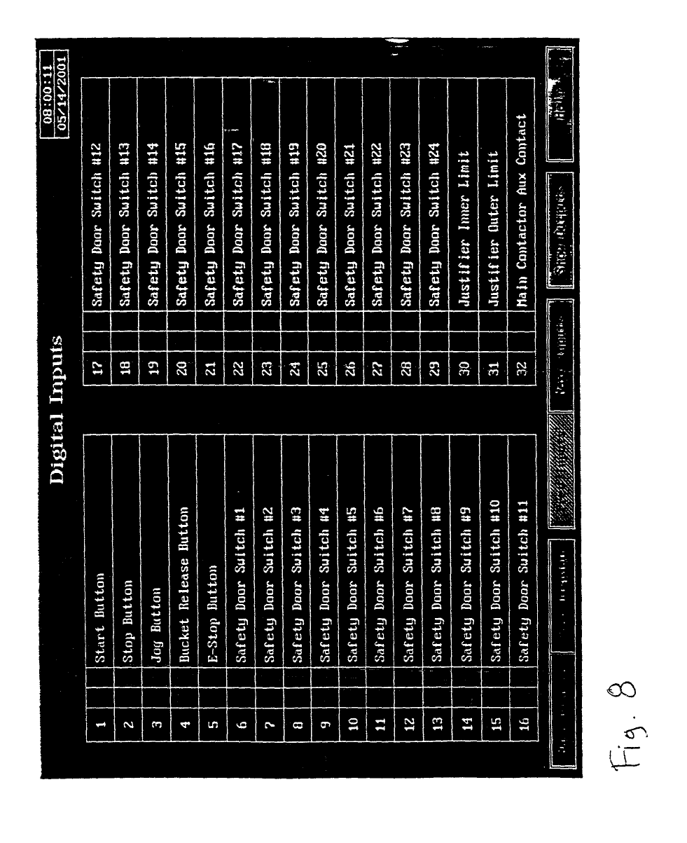

Another diagnostic tool available is for the Serial Real-Time Communications Standard (SERCOS) interface between digital motion controls and drives, as shown in FIG.7. The SERCOS diagnostics includes error messages, status information, hardware and software versions, including phase and cycle time.

### Digital Inputs/Outputs

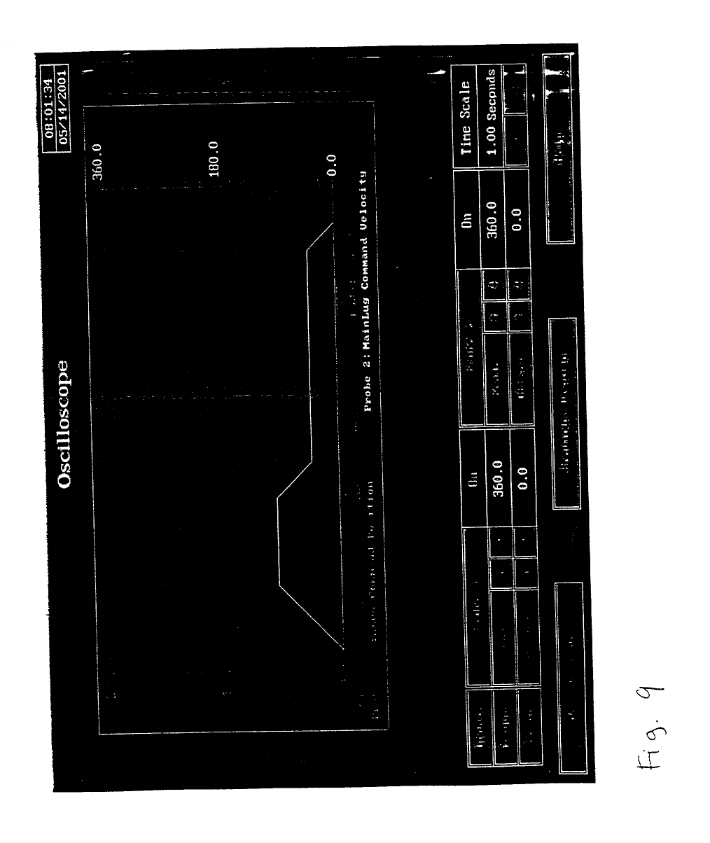

Looking at FIG. 8, digital inputs can also be monitored in a preferred embodiment using the integrated control system for a packaging machine, such digital inputs include a main conveyer. Servo motor, a cutoff knife servo motor and a sweeper arm servo motor and a plurality of safety door switches. Digital outputs include a plurality of valves such as a discharge reject solenoid valve, a justifier pusher solenoid valve and a glue head solenoid valve.

### Oscilloscope

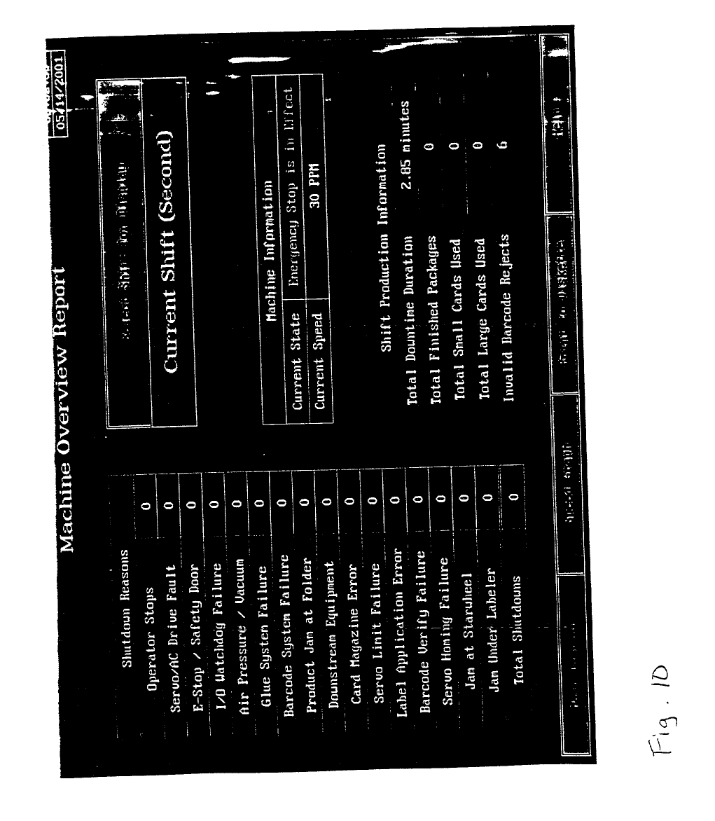

Also, an oscilloscope on the MMI keeps track of user-defined inputs and outputs from probes within the system, a shown in FIG. 9. The outputs may include velocity of the cutoff knife and the sweeper arm command. For instance, an operator can specify a trigger signal for a particular axis. For example, the command portion, actual portion, command velocity to actual velocity can be monitored via the oscilloscope. Also, the to digital input/output signals and the PLC signals such as the PLC control bit and PLC data register may be specified.

### Operational Report

As shown in FIG. 10, an overview report pertaining to the machine process is possible, the data being acquired from sensors and probes. The report includes current operational information of the machine such as speed. Also available is failure related information, an example includes reasons for shutting down the machine, such as, operator stops, servo dive fault emergency stop, input/output watch dog failure and servo housing failure.

In operation, the PLC 26 works by continually scanning a program and the scan cycle consists of 3 important steps. Although, there are typically more than 3, in this example the focus is on the important parts. Typically the others are checking the system and updating the current internal counter and timer values.

Step 1—CHECK INPUT STATUS—First the PLC 26 inspects each input to determine if it is on or off. The PLC 26 records this data into its memory to be used during the next step.

Step 2—EXECUTE PROGRAM—Next the PLC 26 executes your program one instruction at a time. Since the PLC 26 is aware of which inputs are on/off from the previous step it will be able to determine which output should be turned on based on the state of the first input. The PLC 26 will store the execution results for use later during the next step.

Step 3—UPDATE OUTPUT STATUS—Finally the PLC 26 updates the status of the outputs. It updates the outputs based on which inputs were on during the first step and the results of executing your program during the second step. Based on the example in step 2 it would now turn on the first output because the first input was on and your program said to tun on the first output when this condition is true.

After the third step the PLC 26 goes back to step one and repeats the steps continuously. One scan time is defined as the time it takes to execute the 3 steps listed above.

In another embodiment, the control system is operable remotely via a computer network such as a local-area network or the Internet.

The above-described embodiments of the invention are intended to be examples of the present invention and alterations and modifications may be effected thereto, by those of skill in the art without departing from the scope of the invention which is defined solely by the claims appended hereto.

United States Patent & Trademark Office Office of Initial Patent Examination - Scanning Division Application deficienc'es found during scanning: r7 Page(s) of______ were not present for scanning. (D)ocument title) mPage(s) of were not present for scani (Document title) a Scanned copde is best available. di i,g:

United States Patent & Trademark Office Office of Initial Patent Examination - Scanning Division cation deficiencies found during scanning: 0 Page(s) of were not present scanning. (Document title) Page(s) of were not present scanning. (Docwnent title) o Scanned copy is best available.

The embodiments of the invention in which an exclusive property or privilege is claimed are defined as follows:

1. An integrated control system for controlling a machine, said machine having at least one input signal and at least one output signal, said system having:
a means for programming said system with instructions for control functions for the machine;
a meant for displaying said instructions and control functions;
a means for gathering data relevant to said control functions;
a means for storing said data and instructions;
a mean for accessing said data, instructions and presenting said data and instructions in a predetermined format for execution of said control functions an interface means between said system and said machine;
a processor means for executing said instructions, processing said gathered data and for managing said interface means;
whereby said programming means, said display means, said data gathering means and processor means are in communication with said memory means via a bus.

2. The system of claim 1, wherein said machine is interfaced to said system via an input/output module, said input/output module for gathering data from sensors associated with said machine and for imparting control functions to actuators associated with said machine.

3. The system of claim 17 wherein said instructions are user-defined programs for examining status of selected sensing devices and controls actuating devices, said status examination defined to execute periodically.

4. The system of claim 1, wherein said memory means is divided into a plurality of segments for storing data, instructions and operating system calls, said plurality of segments communicatively linked to each other for efficient data storage and data retrieval, and execution of instructions.

5. The system of claim 4, wherein said memory means is RAM, ROM, a mass storage device, said mass storage device including a CD-ROM and a hard drive.

6. The system of claim 1, wherein said system is programmed via a visual display interface and a input means, said input means being a keyboard, a touch-screen or a microphone coupled to a voice-recognition engine.

7. The system of claim 6, wherein said visual display interface is capable of input and output signals at various point of the system architecture, and further displaying said instructions.

8. The system of claim 1, wherein said instructions are readily configurable and customizable to suit an application by manipulating visual C.A.S.E, modules based on a ladder diagram PLC programing language.

9. A method of controlling a machine process, said machine having at least on input signal and at least one output signal, said method having the steps of:
programming instructions associated with control instructions for said machine, gathering data relevant to said control functions from said machine displaying said instructions and control functions; continuously retrieving and displaying changing data associated with said input signals and said output signals;
storing said relevant data and instructions in a memory means;
accessing said relevant data, instructions and presenting said relevant data and instructions in a predetermined format for execution of said control functions and processing said relevant data and executing said instructions.

10. The method of claim 9, wherein said memory means is accessible by any virtual component of a control system for controlling a machine via bus means, for data storage and retrieval.
